(19) United States
(12) Patent Application Publication
(10) Pub. No.: US 2006/0017667 A1
(43) Pub. Date: Jan. 26, 2006

(54) Drive device and drive method of self light emitting display panel and electronic equipment equipped with the drive device

(75) Inventors: Shuichi Seki, Yonezawa-shi (JP); Katsuhiro Kanauchi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/184,825

(22) Filed: Jul. 20, 2005

(30) Foreign Application Priority Data
Jul. 23, 2004 (JP) 2004-215917

(51) Int. Cl. G09G 3/30

(52) U.S. Cl. 345/76

(57) ABSTRACT

A drive device of a self light emitting display panel which is equipped with a plurality of organic EL elements 14 arranged at intersection positions between a plurality of data lines and plurality of scan lines comprises a first gradation control means for time-dividing a frame period into a plurality of subframe periods and setting gradation of each pixel by the sum of lighting periods of one or plural subframe periods, a second gradation control means for treating mutually adjacent plural pixels as a group and performing dither processing on a per group basis, and a reverse bias voltage applying means 27 for applying a reverse bias voltage to the light emitting elements. A subframe period to be a non-lighting period is provided in the plural subframes so that during this period the reverse bias voltage is applied to all light emitting elements by the reverse bias voltage applying means.

### BACKGROUND OF THE INVENTION

1. Field of the Invention

The present invention relates to a drive device and a drive method of a self light emitting display panel and electronic equipment equipped with the drive device, wherein one frame period is respectively time-divided into a plurality of subframe periods and wherein the respective subframe periods are controlled for lighting so that gradation expression is performed.

2. Description of the Related Art

A display employing a display panel constituted by arranging light emitting elements in a matrix pattern has been developed widely. As a light emitting element employed in such a display panel, for example an organic EL (electroluminescent) element in which an organic material is employed in a light emitting layer has attracted attention.

As a display panel employing such organic EL elements, there is an active matrix type display panel in which respective active elements for example constituted by TFTs (thin film transistors) are added to respective EL elements arranged in a matrix pattern. This active matrix type display panel can realize low power consumption and has a characteristic that crosstalk among pixels is small, so that it is particularly suitable for a high definition display constituting a large screen.

FIG. 1 shows one example of a circuit structure corresponding to one pixel 10 in a conventional active matrix type display panel. In FIG. 1, gate G of a TFT 11 that is a control transistor is connected to a scan line (scan line A1), and the source S is connected to a data line (data line B1). The drain D of this control TFT 11 is connected to gate G of a TFT 12 that is a drive transistor and is connected to one terminal of a charge-retaining capacitor 13.

The drain D of the drive transistor TFT12 is connected to the other terminal of the capacitor 13 and to a common anode 16 formed in the panel. The source S of the drive TFT 12 is connected to the anode of an organic EL element 14, and the cathode of this organic EL element 14 is connected to a common cathode 17 constituting for example a reference potential point (ground) formed in the panel.

FIG. 2 schematically shows a state in which the circuit structure having the respective pixel 10 shown in FIG. 1 is arranged in a display panel 20, and the respective pixels 10 of the circuit structure shown in FIG. 1 are formed at respective intersection positions between respective scan lines A1 to An and respective data lines B1 to Bm. In this structure, the drain D of the drive TFT 12 is respectively connected to the common anode 16 shown in FIG. 2, and the cathode of the EL element 14 is respectively connected to the common cathode 17 shown in FIG. 2 similarly. In this circuit, when lighting control is performed, a switch 18 is connected to the ground as shown in the drawing, and thus a voltage source +VD is supplied to the common anode 16.

In this state, when an ON voltage is supplied to the gate G of the control TFT 11 in FIG. 1 via the scan line, the TFT 11 allows current corresponding to the voltage which is supplied from the data line to the source S to flow from the source S to the drain D. Accordingly, during the time when the gate G of the TFT 11 is the ON voltage, the capacitor 13 is charged, and its voltage is supplied to the gate G of the drive TFT 12, so that current based on the gate and drain voltages of the TFT 12 is allowed to flow from the source of the TFT 12 to the common cathode 17 via the EL element 14 to allow the EL element 14 to emit light.

When the gate G of the TFT 11 becomes an OFF voltage, the TFT 11 becomes so-called cut-off. Although the drain D of the TFT 11 is in an open state, the voltage of the gate G in the drive TFT 12 is retained by electrical charges accumulated in the capacitor 13 so that drive current is maintained until a next scan, and light emission of the EL element 14 is also maintained. Since a gate input capacitance exits in the drive TFT 12, even when the capacitor 13 is not provided particularly, an operation similar to the above can be performed.

There is a time gradation method as a method to perform gradation display of image data, employing the above-described circuit structure. In this time gradation method, for example one frame period is time-divided into a plurality of subframe periods to achieve halftone display by the total of subframe periods during which organic EL elements emit light during one frame period.

This time gradation method includes a method in which EL elements are illuminated on a per subframe basis to achieve gradation expression by a simple total of subframe periods during which illumination is achieved (for convenience, referred to as a simple subframe method) as shown in FIG. 3 and a method in which treating one or plural subframe periods as a group, gradation bits are allocated to the group to perform weighting to achieve gradation expression by a combination thereof (for convenience, referred to as a weighting subframe method) as shown in FIG. 4. FIGS. 3 and 4 show examples of a case where gradations 0 to 7 of 8 gradations are displayed.

The weighting subframe method as shown in FIG. 4 has an advantage that multi-gradation display can be realized by the number of subframes that is smaller than that of the simple subframe method as shown in FIG. 3. However, in this weighting subframe method, since gradation is expressed by a combination of illumination which is dispersive in a time domain with respect to one frame image, contour noise called animation pseudo-contour noise (hereinafter simply referred to also as pseudo-contour noise) sometimes occurs, this has been a cause of image quality deterioration. This pseudo-contour noise will be described with reference to FIG. 5. FIG. 5 is a view for explaining an occurrence mechanism of the pseudo-contour noise. FIG. 5 explains a case where four groups (group 1 to 4) of subframes which are weighted to obtain intensities of power of 2 (weights 1, 2, 4, 8) are arranged in the order of low intensity as an example.

An image in which the lower a position of a display screen the more intensity increments, stepping one step on a per pixel basis, that is, an image whose intensity changes smoothly, is considered, and this image is supposed to move in an upward direction for one pixel after one frame time elapses. As illustrated, although the gap of on-screen display positions of frame 1 and frame 2 is one pixel, in human eyes, a break in this image movement cannot be recognized.

However, since the human eye has a characteristic of following the moving intensity, the human eye unintentionally follows a group of subframes which are not illuminated for example between intensity 7 and intensity 8 regarding which an illumination pattern largely changes due to the carry, and the human eye sees the screen as if black pixels of intensity 0 are moving. Accordingly, the human eye recognizes an intensity which does not exist originally, and this is perceived as contour noise. In this manner, when the same gradation data is displayed by the same pixels in continuing frames, in a case where the illumination patterns in respective frames are the same, pseudo-contour noise is easy to occur.

Countermeasure methods for such pseudo-contour noise include a method of increasing the frame frequency, a method of increasing the number of subframes constituting one frame, and the like. That is, in these methods, switching speed of the illumination pattern is increased to restrict visual recognition for intensity changes that become a cause of pseudo-contour so as to reduce pseudo-contour noise.

Gradation display in which means is provided for an illumination pattern of one frame data in order to restrain occurrence of animation pseudo-contour disturbance is disclosed for example in Japanese Patent Application Laid-Open No. 2001-125529 (page 3, right column, line 45 through page 4, left column, line 9, and FIG. 2).

With the methods described above, perception of pseudo-contour noise in human vision can be reduced. However, in order to increase the number of subframes in one frame or to increase a frame frequency, it is necessary that an operational clock frequency is set at a higher frequency, and the operable frequency capability of a circuit has to correspond to it. Further, when the operational frequency is increased in such a manner, a problem that power consumption is increased occurs. Moreover, in the above-described methods, even though the pseudo-contour noise can be reduced to some degree, the principle that gradation is expressed through a combination of illuminations which are dispersive in the time domain does not change therein, and thus its occurrence cannot be restrained completely.

Since the organic EL element is a current injection type light emitting element, current flowing in a wiring resistance applied to the element largely depends on the lighting ratio of a light emitting display panel. That is, if the lighting ratio changes so as to be largely increased, the voltage drop amount of the wiring resistance increases, and, as a result, the drive voltage of the element decreases, and a phenomenon that the light emission intensity decreases occurs. The risk of occurrence of this phenomenon is high in the weighting subframe method in which the lighting ratio is likely to vary drastically, and in this case, there is a problem that gradation expression is deteriorated so that normal gradation expression cannot be achieved (occurrence of gradation abnormality).

### SUMMARY OF THE INVENTION

The present invention has been developed, paying attention to the above-described technical problems, and it is an object of the present invention to provide a drive device and a drive method of a self light emitting display panel and electronic equipment equipped with the drive device wherein in a self light emitting display panel in which self light emitting elements are arranged in a matrix pattern, occurrence of pseudo-contour noise and gradation abnormality can be restrained and while multi-gradation processing is performed, noise pattern resulting from multi-gradation processing can be reduced.

A drive device of a self light emitting display panel according to the present invention which has been developed in order to solve the problem is a drive device of a self light emitting display panel which is equipped with a plurality of light emitting elements arranged at intersection positions between a plurality of data lines and plurality of scan lines, comprising a first gradation control means for time-dividing a frame period into a plurality of subframe periods and setting gradation of each pixel by the sum of lighting periods of one or plural subframe periods, a second gradation control means for treating mutually adjacent plural pixels as a group and performing dither processing on a per said group basis, and a reverse bias voltage applying means for applying a reverse bias voltage to said light emitting elements, wherein a subframe period to be a non-lighting period is provided in said plural subframes so that during said period said reverse bias voltage is applied to all light emitting elements by said reverse bias voltage applying means.

A drive method of a self light emitting display panel according to the present invention which has been developed in order to solve the problem is a drive method of a self light emitting display panel which is equipped with a plurality of light emitting elements arranged at intersection positions between a plurality of data lines and plurality of scan lines, characterized by executing a first gradation control means which is for time-dividing a frame period into a plurality of subframe periods and for setting gradation of each pixel by the sum of lighting periods of one or plural subframe periods, a second gradation control means which is for treating mutually adjacent plural pixels as a group and for performing dither processing on a per said group basis, and a reverse bias voltage applying means which is for applying said reverse bias voltage to all light emitting elements during a subframe period provided to be a non-lighting period among said plural subframe periods.

### BRIEF DESCRIPTION OF THE DRAWINGS

FIG. 1 is a view showing one example of a circuit structure corresponding to one pixel in a conventional active matrix type display panel;

FIG. 2 is a view schematically showing a state in which the circuit structure having each pixel shown in FIG. 1 is arranged in a display panel;

FIG. 3 is a timing diagram for explaining a simple subframe method in a time gradation method;

FIG. 4 is a timing diagram for explaining a weighting subframe method in the time gradation method;

FIG. 5 is a view for explaining an occurrence mechanism of animation pseudo-contour disturbance;

FIG. 6 is a block diagram showing one embodiment according to a drive device and a drive method of the present invention;

FIG. 7 is a view showing one example of a circuit structure of one pixel among pixels respectively arranged in a matrix pattern on the display panel of FIG. 6;

FIG. 8 is a block diagram for explaining internal processing of the data conversion circuit of FIG. 6;

FIG. 9 is a view showing one example of arrangements of dither coefficients in two consecutive frames;

FIG. 10 is a view showing one example of arrangements of dither coefficients in four consecutive frames;

FIG. 11 is views showing one example of arrangement patterns of dither coefficients in different color pixels;

FIG. 12 is one example of a data conversion table employed in the data conversion circuit of FIG. 6;

FIG. 13 is a timing diagram showing one example of subframe light emitting periods of respective frames in the drive device and the drive method of FIG. 6;

FIG. 14 is a graph showing a non-linear gradation characteristic;

FIG. 15 is another example of a data conversion table employed in the data conversion circuit of FIG. 6; and

FIG. 16 is graphs showing gradation characteristics in an even numbered frame and an odd numbered frame.

### DESCRIPTION OF THE PREFERRED EMBODIMENTS

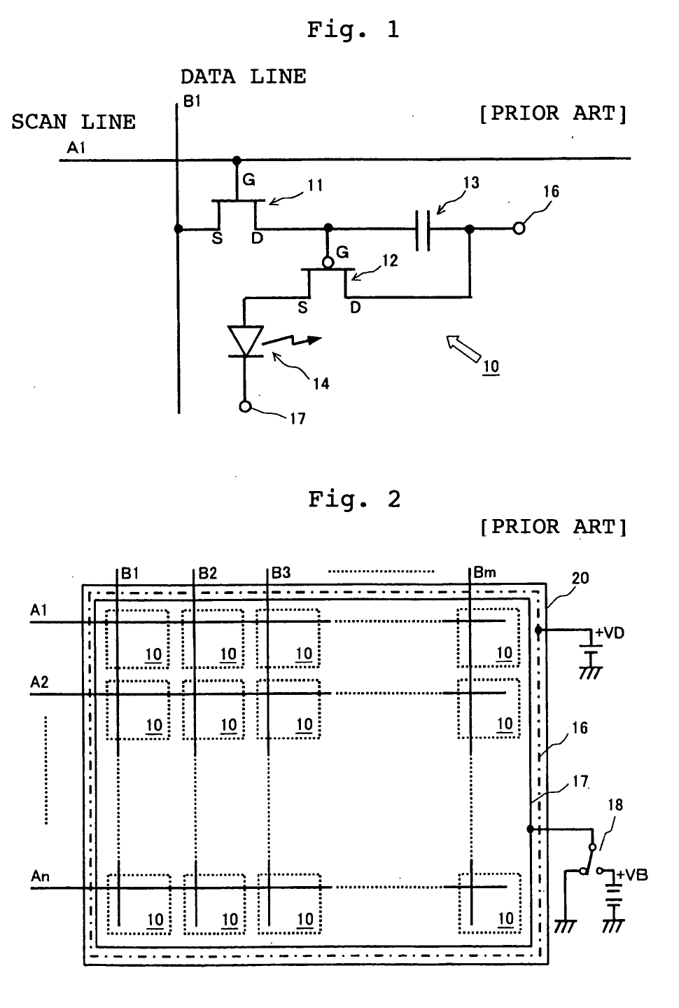

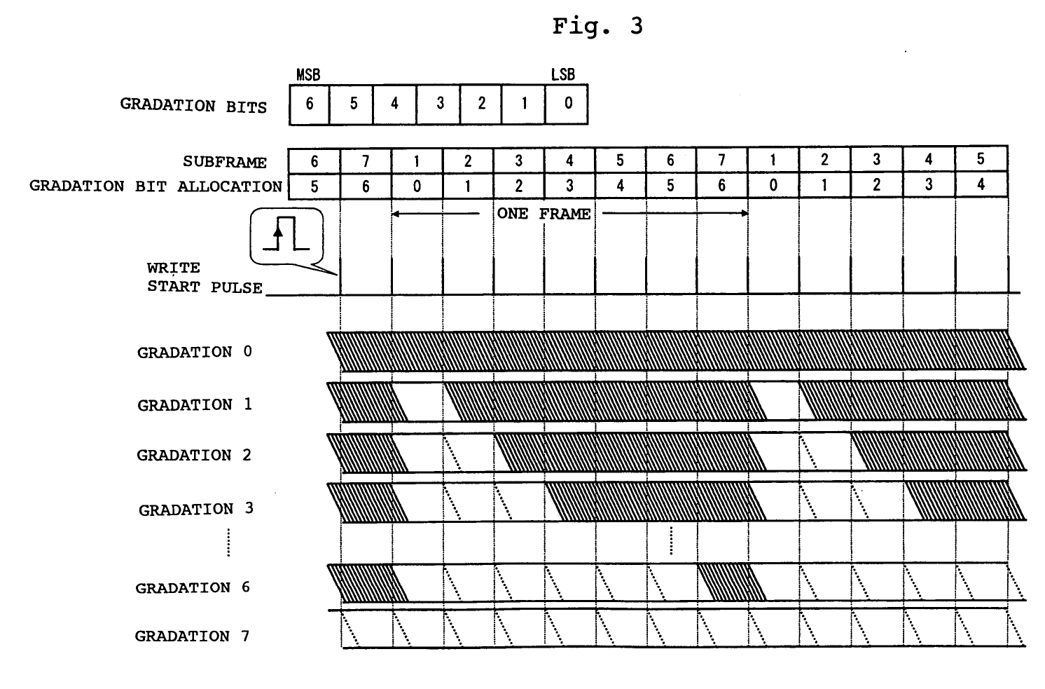

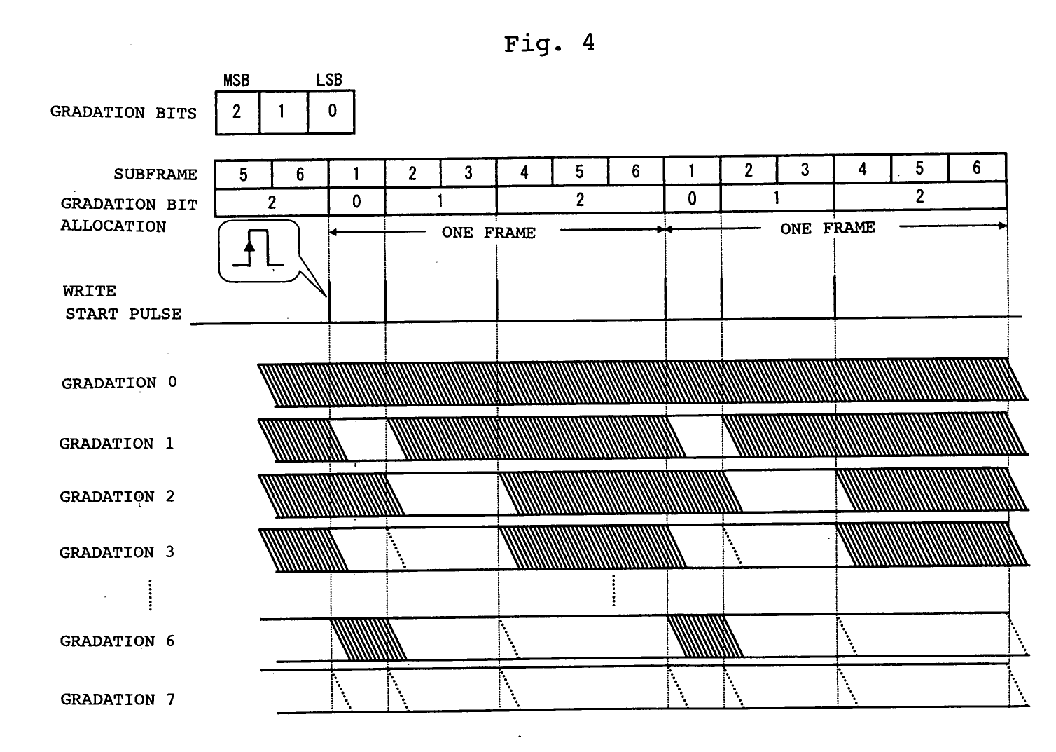

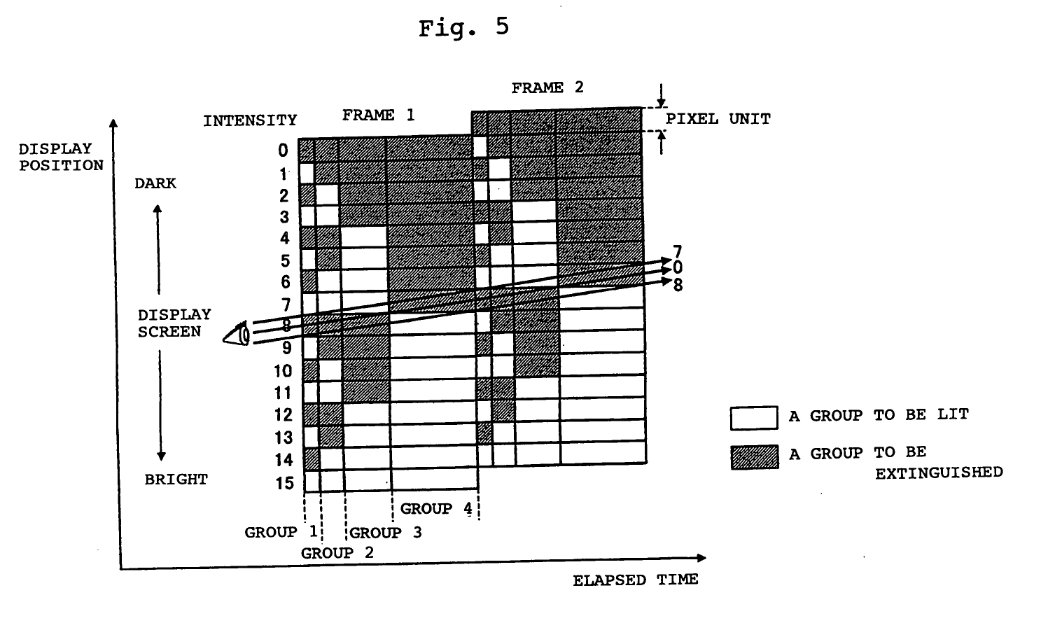

A drive device and a drive method of a self light emitting display panel according to the present invention will be described below based on an embodiment shown in the drawings. In the description below, parts corresponding to respective parts shown in FIGS. 1 and 2 already described are designated by the same reference characters, and therefore description of respective functions and operations will be omitted properly.

The conventional example shown in FIGS. 1 and 2 shows an example of a so-called single-colored light emission display panel in which a series circuit of the drive TFT 12 and the EL element 14 constituting a pixel is all connected between the common anode 16 and the common cathode 17. However, a drive method and a drive device of a self light emitting display panel according to the present invention described below can be appropriately adopted not only in a single-colored light emission display panel but rather in a color display panel equipped with respective light emitting pixels (sub-pixels) of R (red), G (green), and B (blue).

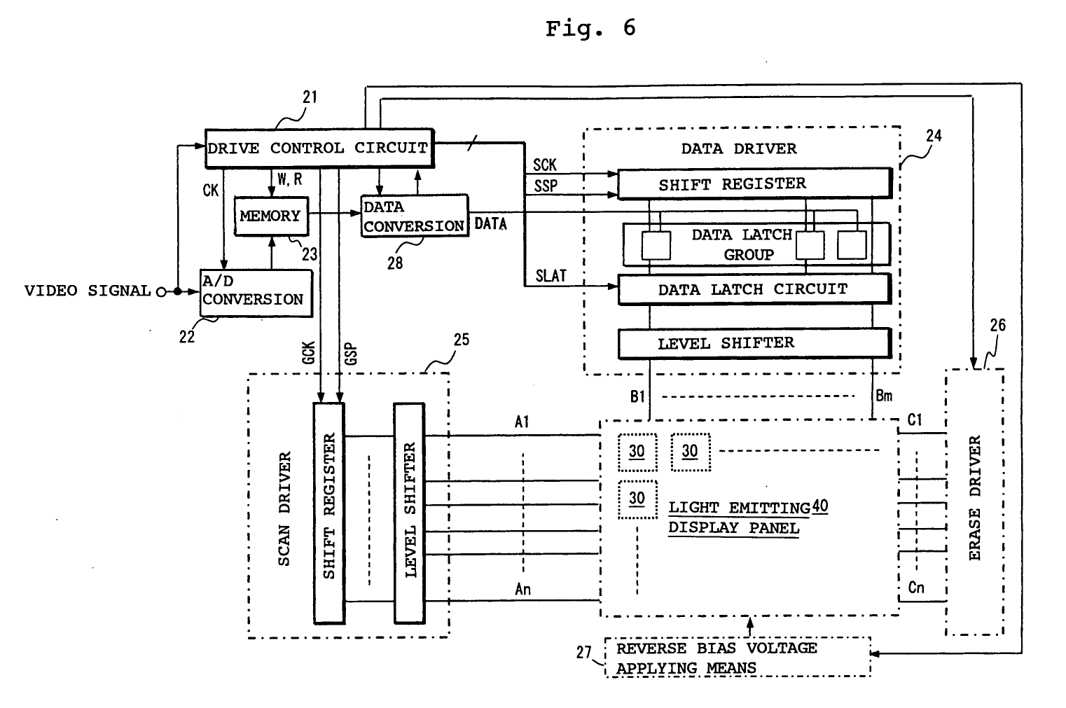

FIG. 6 shows one example of a drive device and a drive method according to the present invention by a block diagram. In FIG. 6, a drive control circuit 21 controls the operation of a light emitting display panel 40 comprised of a data driver 24, a scan driver 25, an erase driver 26, and pixels 30 that are respectively arranged in a matrix pattern.

First, an inputted analog video signal is supplied to the drive control circuit 21 and an analog-to-digital (A/D) converter 22. The drive control circuit 21 generates a clock signal CK for the A/D converter 22 and a write signal W and a read signal R for a frame memory 23 based on horizontal and vertical synchronization signals in the analog video signal.

The A/D converter 22 samples the inputted analog video signal based on the clock signal CK supplied from the drive control circuit 21 to convert it to corresponding pixel data for one pixel to supply it to the frame memory 23. The frame memory 23 operates to sequentially write respective pixel data supplied from the A/D converter 22 in the frame memory 23 by the write signal W supplied from the drive control circuit 21.

By such a write operation, when writing of data of one screen (n rows and m columns) in the self light emitting display panel 40 is completed, the frame memory 23 sequentially supplies for example 6 bits of pixel data to a data conversion circuit 28 for each one pixel by the read signal R supplied from the drive control circuit 21.

The data conversion circuit 28 performs a later-described multi-gradation processing and converts the pixel data of 6 bits to pixel data of 4 bits to supply this from first line to nth line to the data driver 24 per each one line.

Meanwhile, a timing signal is sent from the drive control circuit 21 to the scan driver 25, and based on this the scan driver 25 sequentially sends a gate ON voltage to respective scan lines. Accordingly, drive pixel data of each one line which is read out of the frame memory 23 and which is data converted by the data conversion circuit 28 as described above is addressed per each one line by scanning of the scan driver 25.

In this embodiment, a control signal is sent from the drive control circuit 21 to the erase driver 26.

The erase driver 26 receives the control signal from the drive control circuit 21 and selectively applies a predetermined voltage level to electrode lines (referred to as control lines C1 to Cn in this embodiment) which are electrically separated and arranged for each scan line as described later to control ON/OFF operation of a later-described erase TFT 15.

Further, the drive control circuit 21 sends a control signal to a reverse bias voltage applying means 27. This reverse bias voltage applying means 27 operates to receive the control signal, selectively apply the predetermined voltage level to a cathode electrode 32, and supply a forward or reverse bias voltage to organic EL elements. This reverse bias voltage is a voltage of a direction which is reverse to the direction (forward direction) in which current flows at the time of light emission and is applied to respective organic EL elements during a period which does not relate to a light emission period which is for image data display. By applying the reverse bias voltage in this manner, it has been known that light emission lifetime of the element can be prolonged with respect to elapsed time.

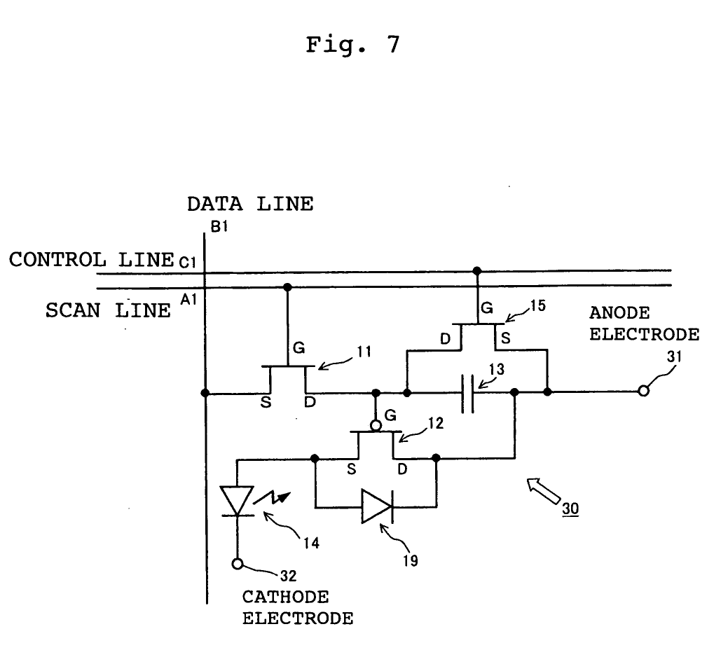

FIG. 7 is a view showing an example of a circuit structure of one pixel among the pixels 30 respectively arranged in a matrix pattern on the self light emitting display panel 40. The example of the circuit structure corresponding to one pixel 30 shown in this FIG. 7 is applied to an active matrix type display panel. This circuit is constructed such that the TFT 15 that is an erase transistor for erasing electrical charges accumulated in the capacitor 13 is added to the circuit structure of the pixel 10 shown in FIG. 1 and that a diode 19 which is connected between the source S and the drain D of the lighting drive TFT 12 for bypassing this is added thereto further.

In the first place, the erase TFT 15 is connected in parallel to the capacitor 13 and performs an ON operation in accordance with the control signal provided from the drive control circuit 21 while the organic EL element 14 is in a lighting operation, so that electrical charges of the capacitor 13 can be discharged instantly. Thus, until a next addressing time, pixels can be extinguished.

Meanwhile, the anode of the diode 19 is connected to the anode of the EL element 14, and the cathode of the diode 19 is connected to an anode electrode 31. Accordingly, the diode 19 is connected in parallel between the source S and the drain D of the drive TFT 12 so that the direction thereof becomes a direction which is reverse to the forward direction of the EL element 14 having a diode characteristic.

In the circuit structure shown in FIG. 7, the cathode of the EL element 14 is connected to a cathode electrode 32 commonly formed with respect to the scan lines A1 to An, so that selectively the predetermined voltage level is applied to this cathode electrode by the reverse bias voltage applying means 27 shown in FIG. 6. That is, here, in a case where the voltage level applied to the common anode 31 is “Va”, for example, a voltage level of “Vh” or “V1” is selectively applied to the cathode electrode 32. The level difference of “V1” with respect to the “Va”, that is, Va to V1, is set so as to create a forward direction (for example, of the order of 10 volts) in the EL element 14, and thus in a case where “V1” is selectively set at the cathode electrode 32, the EL elements 14 constituting the pixels 30 respectively become in an emittable state.

The level difference of “Vh” with respect to the “Va”, that is, Va to Vh, is set so as to create a reverse bias voltage (for example, around −8 volts) in the EL element 14, and thus in the case where “Vh” is selectively applied to the cathode electrode 32, the EL elements 14 constituting the pixels 30 respectively become in a non-light emitting state. At this time, the diode 19 shown in FIG. 7 is brought to an ON state by the reverse bias voltage.

Now, in the above-described circuit structure, since the supply time (lighting time) of the drive current applied to the EL element that is a light emitting element can be changed, the substantial light emission intensity of the organic EL element 14 can be controlled. Therefore, in the gradation expression in a drive device and a drive method of a self light emitting display panel according to the present invention, the base is the time gradation method. As this time gradation method, in order to completely restrain the occurrence of the animation pseudo-contour noise, and in order to restrain the occurrence of gradation abnormality, the simple subframe method is applied. The gradation expression in the present circuit structure can be realized by a first gradation control means composed of the drive control circuit 21, the data driver 24, the scan driver 25, the erase driver 26, and the respective pixels 30 and a second gradation control means composed of the data conversion circuit 28.

In the drive device and the drive method according to the present invention as described above, although the simple subframe method is employed for gradation expression, in the case where the simple subframe method is employed, heretofore, for example, the number of subframes during one frame period is increased to cope with multi-gradation expression, and as a result, harmful influence resulting from an increase of the operational frequency has occurred.

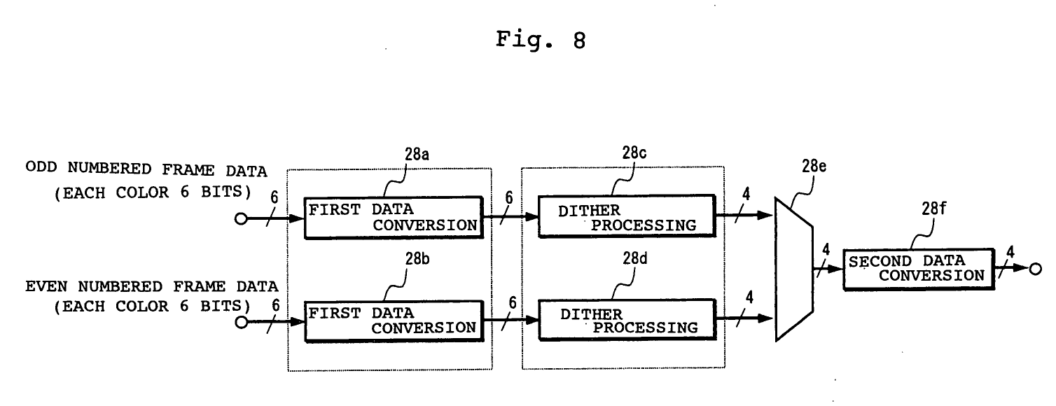

Thereupon, in the drive device and the drive method according to the present invention, in order to realize multi-gradation display without increasing the number of subframes, dither conversion processing centering on dither processing is performed. FIG. 8 is a block diagram for explaining the data conversion circuit 28 performing data conversion processing for the multi-gradation display. As shown in FIG. 8, into the data conversion circuit 28, 6 bits, one pixel of data, for signal paths of respective even numbered frames and odd numbered frames, is sequentially inputted from the frame memory 23. Data conversion processing is performed for the pixel data of even numbered frames and odd numbered frames in first data conversion circuits 28a, 28b, respectively.

The data conversion processing in the first data conversion circuits 28a, 28b is performed, as a preceding process of the dither processing performed in a latter process, for a countermeasure against overflow in the dither processing, a countermeasure against noise by a dither pattern, or the like. Specifically, for example, regarding pixel data of even numbered frames, in the data conversion circuit 28a, among values of 0 to 63 as 6 bit data inputted, values 0 to 58 are outputted as they are, 1 is added to value 57 to be converted to value 58 to be outputted, and values 58 to 63 are converted to value 60 forcibly for overflow prevention to be outputted.

Meanwhile, regarding pixel data of odd numbered frames, in the data conversion circuit 28b, among values of 0 to 63 as 6 bit data inputted, 2 is added to value 0 and values 2 to 57 to be outputted, 1 is added to value 1 to be converted to value 2 to be outputted, and values 58 to 63 are converted to value 60 forcibly for overflow prevention to be outputted. Such conversion characteristics are set in accordance with the number of bits of input data, the number of display gradations, and the number of compression bits by multi-gradation. In this manner, in the first data conversion circuits 28a, 28b, regarding the same value of input pixel data, conversion processings for even numbered frames and odd numbered frames are different, and light emission intensities of respective frames are different from one another even when input pixel data is the same value.

Then, in dither processing circuits 28c, 28d, dither coefficients are added to the 6 bit pixel data for which conversion processing is performed in the first data conversion circuits 28a, 28b, respectively, so that multi-gradation processing is imparted. In these dither processing circuits 28c, 28d, after the dither coefficients are added to intensity data of pixels, low-order 2 bits among 6 bit pixel data are discarded. That is, actual gradation is expressed by high-order 4 bits, and pseudo-gradation display corresponding to 2 bits is realized by dither processing.

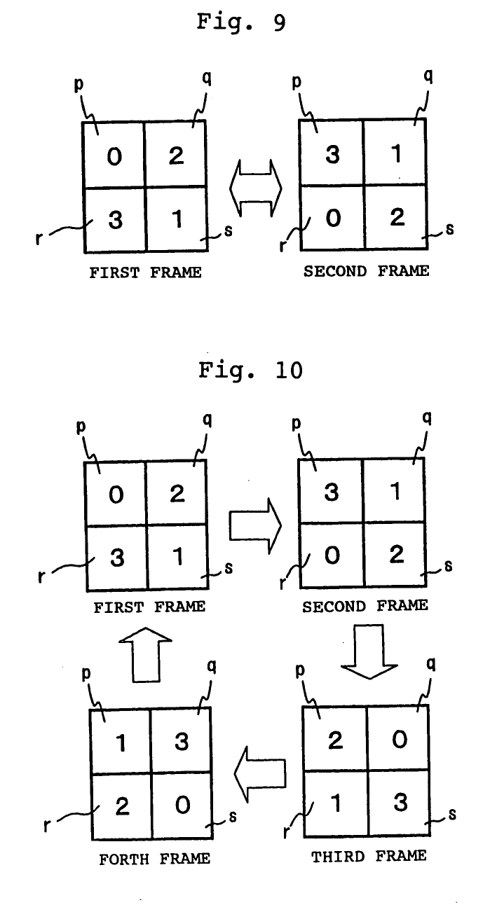

In detail, as shown in FIG. 9, treating four horizontally and vertically adjacent pixels p, q, r, and s as one group, dither coefficients 0 to 3 that are different from one another are allocated to respective pixel data corresponding to respective pixels of this one group to perform addition. With this dither processing, four halftone display level combinations are generated by four pixels. Therefore, even if the number of bits of the pixel data is 4, expressable intensity gradation level becomes four times, that is, halftone display corresponding to 6 bits (64 gradations) becomes possible.

In FIG. 9, numbers (0, 1, 2, and 3) shown in respective pixels represent arrangements of dither coefficients (values) added to respective pixel data. As shown in the drawings, in the first frame and the second frame, dither coefficients added to the same pixel are set so as to be different from each other. At that time, the arrangements of the dither coefficients are set such that the sums of the dither coefficients of the first frame and the second frame in the same pixel are all equal in the four pixels, p, q, r, and s. In the example of FIG. 9, the sums of the dither coefficients of the first frame and the second frame in the same pixel become a value of 3.

The arrangements of such dither coefficients are performed for noise reduction by a dither pattern. That is, when a dither pattern by dither coefficients 0 to 3 is constantly added to the respective pixels, there are cases where noise by this dither pattern is visually confirmed, and image quality is deteriorated. Thus, by varying the dither coefficients for each frame as described above, noise by a dither pattern can be reduced.

Although FIG. 9 shows an example in which the sum of the dither coefficients in two frames in the same pixel is made equal, the present invention is not limited to this, and for example, as shown in FIG. 10, the sum of the dither coefficients in four frames in the same pixel may be made equal. In the example of FIG. 10, the sum of the dither coefficients in four frames in the same pixel is 6.

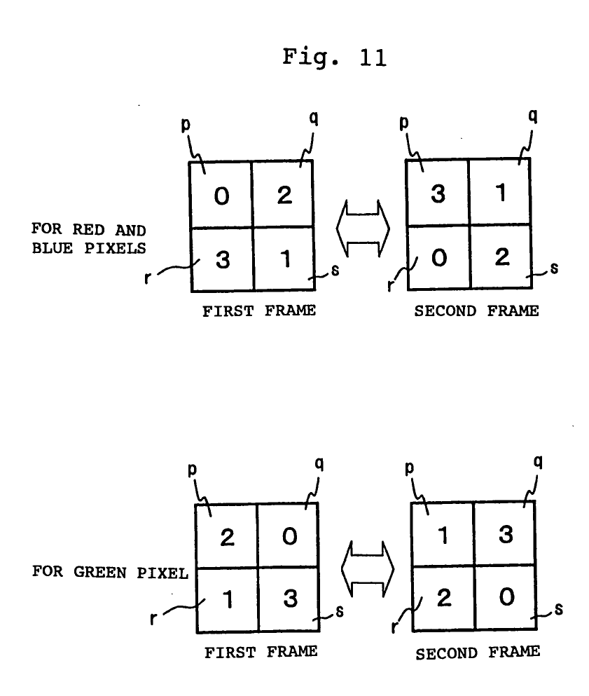

In the case where the light emitting display panel 40 is a color display panel, with respect to respective R (red), G (green), and B (blue) light emission pixels, dither coefficients to be added may be set so as to be different from one another. For example, actual light emission intensities of pixels of red and blue are lower than actual light emission intensities in a green pixel even if they have the same intensity data to be illuminated. Therefore, for example as shown in FIG. 11, regarding red and blue pixels, by the combinations of the same dither coefficients, and regarding a green pixel, by dither coefficients which are different from those of the case of the red and blue pixels, noise by the dither patterns can be further reduced.

The pixel data of 4 bits of even numbered frames and odd numbered frames for which multi-gradation processing is performed in the dither processing circuits 28c, 28d are switched alternately for each pixel data of one line by a selector 28e and are outputted to a second data conversion circuit 28f, as shown in FIG. 8.

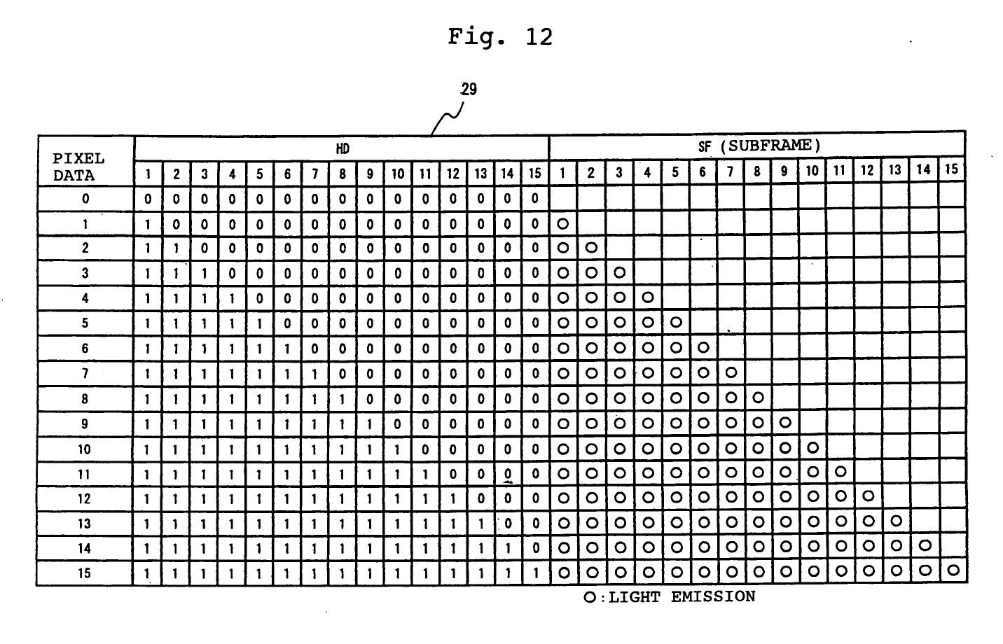

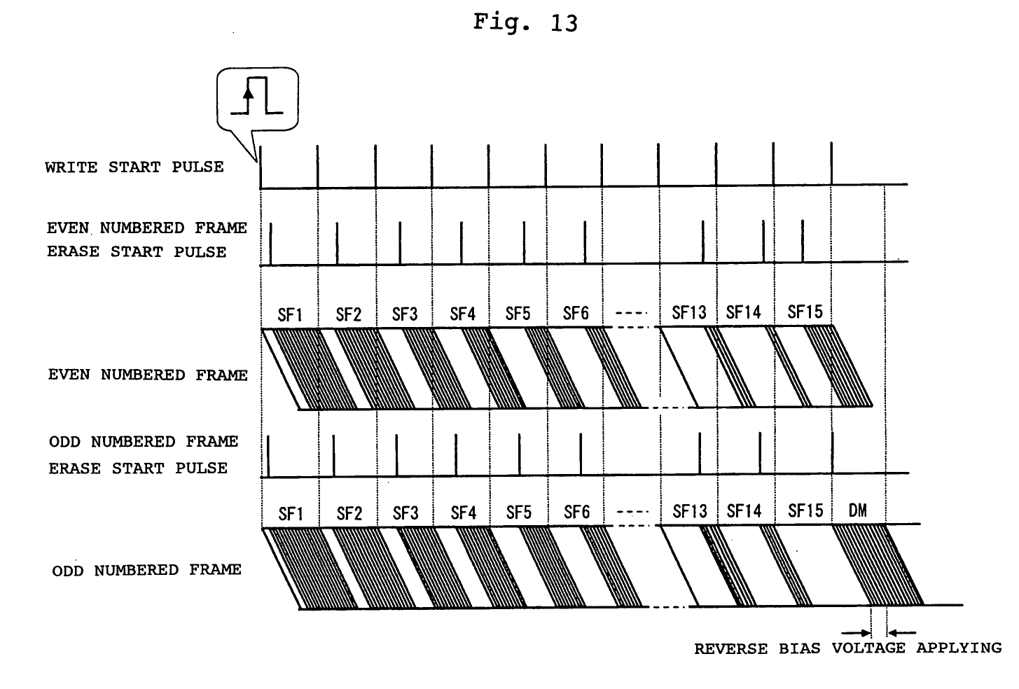

In the second data conversion circuit 28f, pixel data of 4 bits that is any one of the values of 0 to 15 is converted to display pixel data HD constituted by respective first to fifteenth bits corresponding to respective subframes SF 1 to 15 in accordance with a conversion table 29 shown in FIG. 12. In FIG. 12, the bit of logic level “1” in the display pixel data HD represents an execution of pixel light emission at a subframe SF corresponding to this bit.

The display pixel data HD for which such a conversion is performed is supplied to the data driver 24. At this time, the form of the display pixel data HD becomes any one of 16 patterns shown in FIG. 12. The data driver 24 allows the respective first to fifteenth bits in the display pixel data HD to be allocated to the respective subframes SF 1 to 15. Accordingly, in a case where the bit logic is 1, by scanning of the scan driver 25, addressing to a corresponding pixel is performed, and a light emission operation is performed during this subframe period.

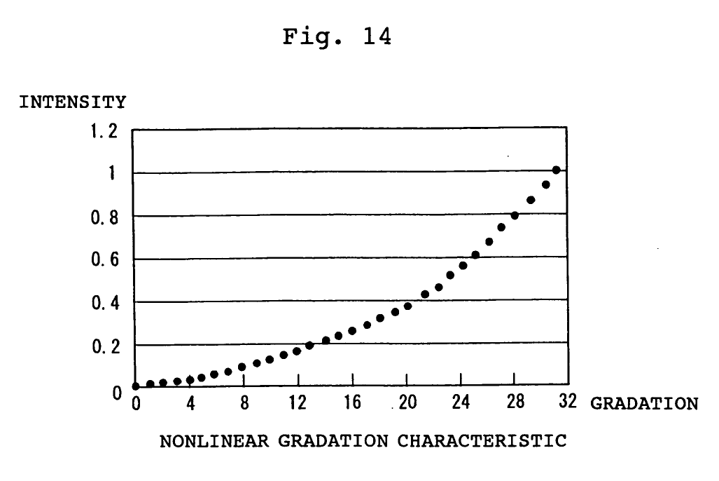

In the drive method according to the present invention, although line data of even numbered frames and odd numbered frames are alternately displayed during one frame period, the ratios of the light emission periods in the respective subframes (SF 1 to 15) in each frame are all made different from one another as shown in FIG. 13. At that time, the lengths of the light emission periods in the respective subframe periods are determined such that an intensity curve in respective gradations displayed by the simple subframe method becomes nonlinear (for example, gamma value 2.2) as shown in FIG. 14. Accordingly, gradation display by the simple subframe method can have a nonlinear characteristic (gamma characteristic), and more natural gradation display can be realized. The erase TFT 15 is driven in accordance with an erase start pulse provided from the drive control circuit 21 to instantly discharge electrical charges of the capacitor 13, so that the light emission periods during the respective subframe periods are generated.

As shown in the drawing, regarding subframe periods of the same number, except for SF15, the light emission periods of odd numbered frames are made shorter than those of even numbered frames. For example, the light emission period of the odd numbered frame in SF3 is set to a middle level length with respect to the light emission periods of SF2 and SF3 in the even numbered frames. That is, in the first data conversion circuit 28a, 28b, regarding data of the odd numbered frames converted to data whose value is greater than that of the even numbered frames, by setting the light emission periods thereof at lengths shorter than the light emission periods of the even numbered frames, divergence in display intensities among respective frames is regulated.

Therefore, in a case where the values of pixel data inputted from the frame memory 23 are the same regarding pixels of even numbered frames and odd numbered frames, although displayed gradations are different from one another regarding respective frames in reality, since the light emission periods of respective frames are different from one another, natural gradation expression is performed without generating divergence of visual intensities. With respect to SF15, the light emission period in the odd numbered frame is set so as to be longer than the light emission period of the even numbered frame, so that the light emission period of one entire frame of an even numbered frame is equal to the light emission period of one entire frame of an odd numbered frame.

In this case, since the light emission period that should be performed in each subframe is different from one another, 2 kinds of light emission operations of 16 gradations (actual gradations) are alternately performed for each frame. By such driving, the number of visual display gradations, when being integrated in the time direction, increases than the case of 16 gradations. Therefore, noise of the dither pattern by the above-described multi-gradation processing (dither processing) becomes difficult to be prominent, and sense of S/N is improved.

However, in this manner, when two kinds of light emission drives in which light emission periods during subframe periods are different from each other in an even numbered frame and an odd numbered frame are performed alternately, since light emission centers during one frame period are different from each other, there are cases where flicker may occur. Thus, in the drive device and drive method according to the present invention, in order to allow light emission centers of respective frames to conform to one another, a dummy subframe (DM) is provided in one side frame (end of the odd numbered frame in FIG. 13) so that this period is a non-lighting period.

Further, the reverse bias voltage is applied to all organic EL elements by the reverse bias voltage applying means 27 during the non-lighting period in this dummy subframe (DM). That is, the reverse bias voltage can be applied without specially providing a period for applying the reverse bias voltage necessary for driving of the light emitting display panel employing organic EL elements.

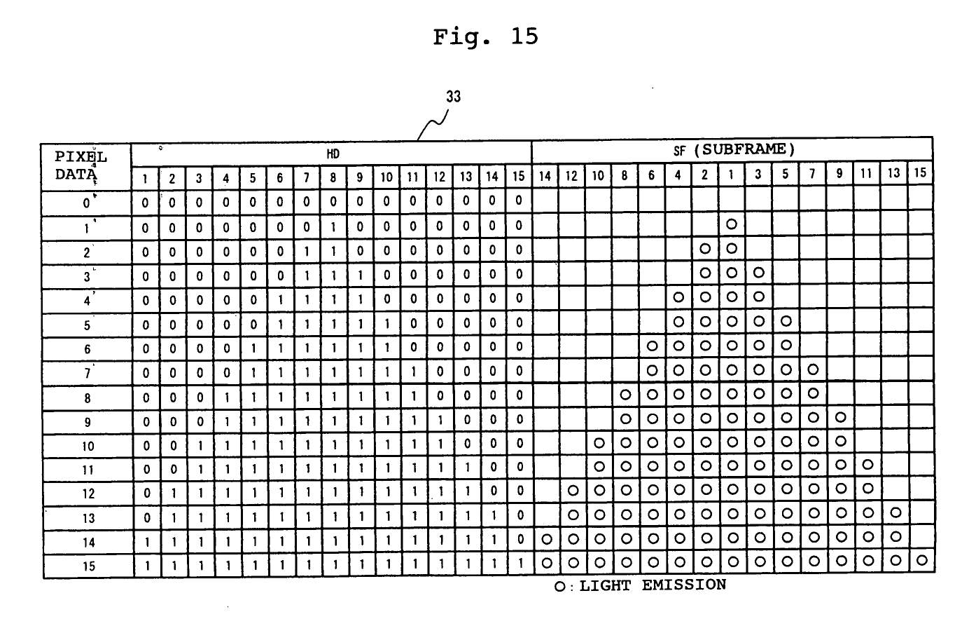

In processing in the second data conversion circuit 28f, a conversion table 33 shown in FIG. 15 may be employed instead of the conversion table 29 shown in FIG. 12. That is, with this conversion table 33, the light emission period in all gradations can be allowed to be the center of one frame period, so that the difference between the light emission centers of an even numbered frame and an odd numbered frame can be made smaller.

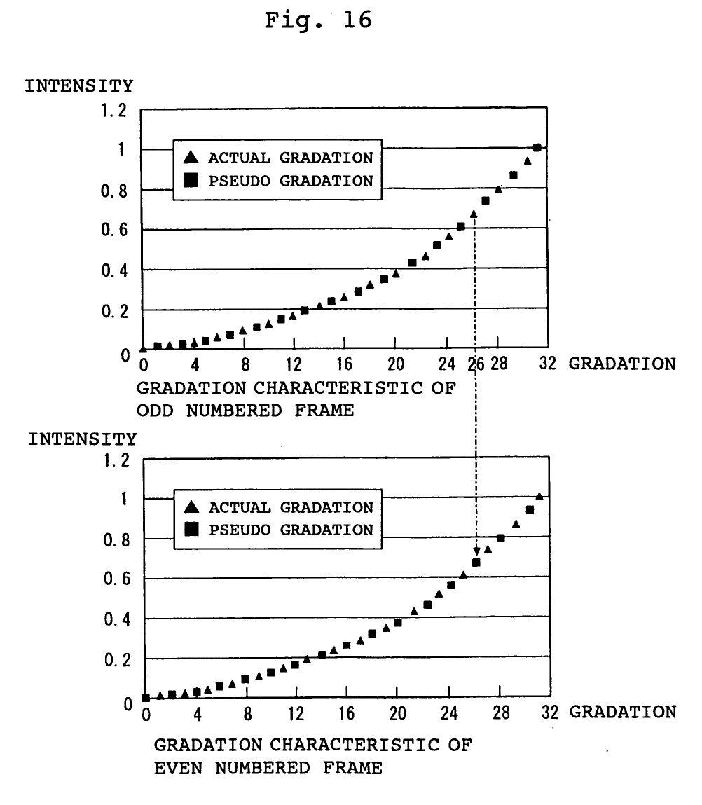

In the drive device and the drive method according to the present invention, in a case where actual gradations by 4 bit pixel data and 64 gradations by the dither processing (pseudo gradations) are expressed, it is preferred that one gradation value to be expressed is separately expressed by only actual gradations and by pseudo gradations for each frame. For example, as shown in graphs of FIG. 16, in a case of gradation value 26 to be expressed, the even numbered frame and the odd numbered frame are not both expressed only by the actual gradations or only by pseudo gradations, but the odd numbered frame is expressed only by the actual gradations by 4 bits while the even numbered frame is expressed by the pseudo gradations by the dither processing. Accordingly, even in the case of display of the same gradation value, since light emission patterns in respective frames are different, noise by the dither pattern can be reduced.

As described above, in the embodiment according to the present invention, since the simple subframe method is adopted instead of the weighting subframe method, for gradation expression, occurrence of animation pseudo-contour noise and gradation abnormality can be completely restrained. Further, multi-gradation processing that is a problem in a case of employing the simple subframe method can be resolved by employing a dither method, and conventionally occurring harmful effects resulting from an increase of the number of subframes can be avoided.

Moreover, by contriving the arrangement of dither coefficients, or by performing setting such that light emission periods in subframes of the same number are different from each other among continuing frames, noise of the dither pattern by employing the dither method can be reduced to improve sense of SIN.

In the structural example shown in FIG. 6, the video signal (pixel data) outputted from the A/D converter 22 is tentatively stored in the frame memory 23 for each one screen and thereafter processed in the data conversion circuit 28. Such a structure is effective in a drive device of a display panel of a cellular telephone or the like in which the video data is not necessarily switched for each frame. However, in a case where the video signal is inputted to the A/D converter 22, since the video signal is inputted for each frame, the video signal (pixel data) outputted from the A/D converter 22 may be sequentially converted in the data conversion circuit 28 to be tentatively stored in the frame memory 23 for each one screen.

Further, although the case of pixel data of 6 bits and 64 of gradation expression is exemplified for convenience in the above-described embodiment, the present invention is not limited to this, and the drive device and the drive method according to the present invention can be applied to a case of display of greater gradations or lower gradations.

What is claimed is:

1. A drive device of a self light emitting display panel which is equipped with a plurality of light emitting elements arranged at intersection positions between a plurality of data lines and plurality of scan lines, comprising a first gradation control means for time-dividing a frame period into a plurality of subframe periods and setting gradation of each pixel by the sum of lighting periods of one or plural subframe periods, a second gradation control means for treating mutually adjacent plural pixels as a group and performing dither processing on a per said group basis, and a reverse bias voltage applying means for applying a reverse bias voltage to said light emitting elements, wherein a subframe period to be a non-lighting period is provided in said plural subframes so that during said period said reverse bias voltage is applied to all light emitting elements by said reverse bias voltage applying means.

2. The drive device of the self light emitting display panel according to claim 1, wherein in a plurality of pixels constituting a group that is be a processing unit of dither processing by said second gradation control means, dither coefficient values which are added to the same pixel in each frame are different from one another on a per plural frames basis.

3. The drive device of the self light emitting display panel according to claim 2, wherein in each pixel constituting a group for which said dither processing is performed, the sum of dither coefficient values which are added in each frame is equal to one another on a per said continuing plural frames basis.

4. The drive device of the self light emitting display panel according to claim 2, wherein said self light emitting display panel is provided with a plurality of colors of light emitting elements, and an arrangement of dither coefficient values in at least one color pixel is different from an arrangement of dither coefficient values for another color pixel in the same frame.

5. The drive device of the self light emitting display panel according to claim 3, wherein said self light emitting display panel is provided with a plurality of colors of light emitting elements, and an arrangement of dither coefficient values in at least one color pixel is different from an arrangement of dither coefficient values for another color pixel in the same frame.

6. The drive device of the self light emitting display panel according to any one of claims 1 to 5, further comprising an erase transistor for discharging and erasing electrical charges from a capacitor which retains a gate potential of said lighting drive transistor, wherein said first gradation display means discharges electrical charges of said capacitor by said erase transistor, an extinction period for extinguishing said light emitting elements is provided, and the ratio of lighting periods in respective subframe periods is allowed to have a nonlinear characteristic.

7. The drive device of the self light emitting display panel according to claim 6, wherein said nonlinear characteristic is a gamma characteristic.

8. The drive device of the self light emitting display panel according to claim 1, wherein said light emitting element is constituted by an organic EL element having a light emission functional layer composed of at least one layer.

9. Electronic equipment comprising the drive device of the self light emitting display panel according to claim 1.

10. A drive method of a self light emitting display panel which is equipped with a plurality of light emitting elements arranged at intersection positions between a plurality of data lines and plurality of scan lines, wherein the method executes a first gradation control means which is for time-dividing a frame period into a plurality of subframe periods and for setting gradation of each pixel by the sum of lighting periods of one or plural subframe periods, a second gradation control means which is for treating mutually adjacent plural pixels as a group and for performing dither processing on a per said group basis, and a reverse bias voltage applying means which is for applying said reverse bias voltage to all light emitting elements during a subframe period provided to be a non-lighting period among said plural subframe periods.

11. A drive method of a self light emitting display panel according to claim 10, wherein in a plurality of pixels constituting a group that is be a processing unit of dither processing by said second gradation control means, dither coefficient values which are added to the same pixel in each frame are different from one another on a per plural frames basis.
